(19) United States
(12) Patent Application Publication
(10) Pub. No.: US 2025/0104269 A1
(43) Pub. Date: Mar. 27, 2025

(54) LANE CHANGE DETECTION USING A GRAPH REPRESENTATION

(71) Applicant: Toyota Jidosha Kabushiki Kaisha, Toyota-shi Aichi-ken (JP)

(72) Inventor: Alexander Christoph Schaefer, Fremont, CA (US)

(21) Appl. No.: 18/473,418

(22) Filed: Sep. 25, 2023

(51) Int. Cl. G06T 7/73; G06T 7/50

(52) U.S. Cl. CPC G06T 7/73; G06T 7/50; G06T 2207/20072; G06T 2207/30256

(57) ABSTRACT

System, methods, and other embodiments described herein relate to implementing lane change detection strategies. In one embodiment, a method includes determining for each segment of a frame graph a left-handed distance and a right-handed distance based on a vehicle position indicator, a set of left lane boundary indicators, and a set of right lane boundary indicators within each segment; and determining if a lane change has occurred by evaluating changes in magnitude within a set of left-handed distances and a set of right-handed distances.

### TECHNICAL FIELD

The subject matter described herein relates, in general, to strategies for detecting lane changes, and, more particularly, to detecting lane changes through a graph representation.

### BACKGROUND

Vehicles may be equipped with sensor systems (e.g., cameras, LiDAR) that gather probe traces (e.g., image data, points clouds, odometry data, GPS data) to detect lane changes by a vehicle.

### SUMMARY

In one embodiment, a lane change detection system is disclosed. The vehicle management system includes one or more processors and a memory communicably coupled to the one or more processors. The memory stores a command module including instructions that when executed by the one or more processors cause the one or more processors to determine for each segment of a frame graph a left-handed distance and a right-handed distance based on a vehicle position indicator, a set of left lane boundary indicators, and a set of right lane boundary indicators within each segment; and determine if a lane change has occurred by evaluating changes in magnitude within a set of left-handed distances and a set of right-handed distances.

In one embodiment, a non-transitory computer-readable medium including instructions that when executed by one or more processors cause the one or more processors to perform one or more functions is disclosed. The instructions include instructions to determine for each segment of a frame graph a left-handed distance and a right-handed distance based on a vehicle position indicator, a set of left lane boundary indicators, and a set of right lane boundary indicators within each segment; and determine if a lane change has occurred by evaluating changes in magnitude within a set of left-handed distances and a set of right-handed distances.

In one embodiment, a method for implementing lane change detection strategies is disclosed. In one embodiment, the method includes determining for each segment of a frame graph a left-handed distance and a right-handed distance based on a vehicle position indicator, a set of left lane boundary indicators, and a set of right lane boundary indicators within each segment; and determining if a lane change has occurred by evaluating changes in magnitude within a set of left-handed distances and a set of right-handed distances.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a lane change detection system that is associated with implementing lane change detection strategies.

FIG. 3 illustrates one example of probe trace data.

FIG. 4 illustrates one example of a frame graph constructed from probe trace data.

FIG. 5 illustrate one example of a lane change.

FIG. 6 illustrate another example of a lane change.

FIG. 7A illustrate one example of a standard lane change.

FIG. 7B illustrate one example of a split/merge lane change.

FIG. 7C illustrate one example of an off-road lane change.

FIG. 7D illustrate one example of a lane splitting condition.

FIG. 8A illustrate one example of a grouping of vehicles.

FIG. 8B illustrates one example of sharing data in a grouping of vehicles.

FIG. 9 illustrates one example of a vehicle contour.

FIG. 10 illustrates one example of a method for implementing lane change detection strategies.

### DETAILED DESCRIPTION

Systems, methods, and other embodiments associated with lane change detection are described herein. With respect to detecting lane changes, automotive systems typically use complex solutions that rely on direct observations of the road ahead to identify lane changes by a vehicle. Such approaches may offer various benefits beyond lane change detection functionality yet may also be too costly for implementation on cost-sensitive vehicle platforms.

Accordingly, systems and methods for detecting lane changes are described herein based on detecting changes in the distances of a vehicle to its nearest lane boundary lines. For example, if a vehicle starts a lane change to the right, the left-handed distance of the vehicle to the left-side lane boundary line will increase, while the right-handed distance of the vehicle to the right-side lane boundary line will decrease. Once the vehicle crosses into the adjacent lane, the left-handed distance to the left-side lane boundary line may suddenly decrease, while the right-handed distance to the right-side lane boundary line may suddenly increase. When such a transition occurs in the left-handed distance, right-handed distance, or both, a lane change may be determined to have occurred.

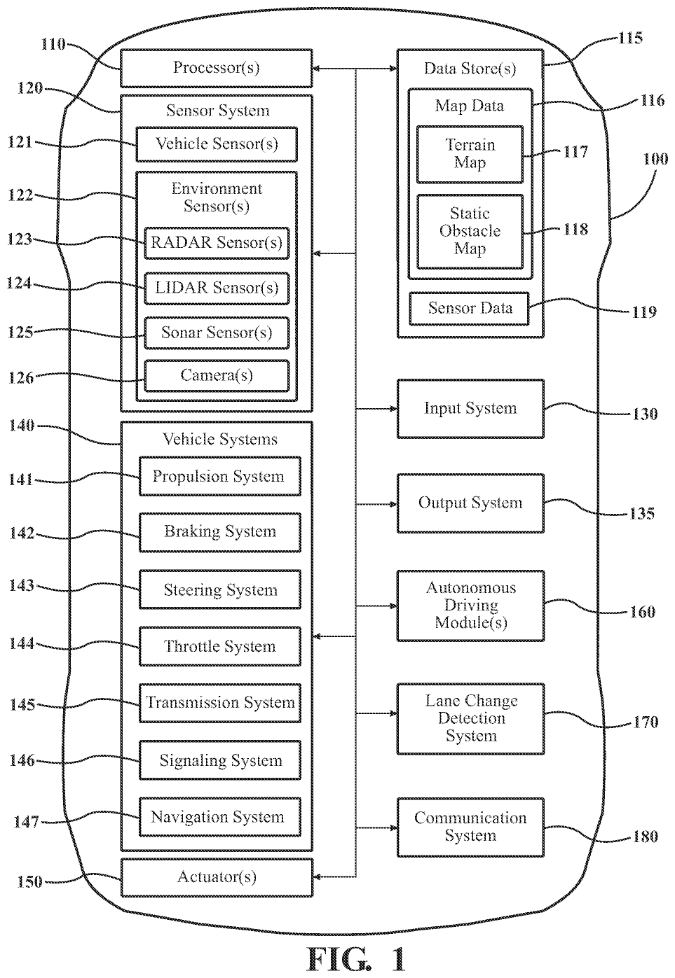

Referring to FIG. 1, an example of a vehicle 100 is illustrated. As used herein, a “vehicle” is any form of motorized transport. In one or more implementations, vehicle 100 is an automobile. While arrangements will be described herein with respect to automobiles, it will be understood that embodiments are not limited to automobiles. In some implementations, vehicle 100 may be any robotic device or form of motorized transport that, for example, includes sensors to perceive aspects of the surrounding environment, and thus benefits from the functionality discussed herein associated with lane change detection strategies. As a further note, this disclosure generally discusses vehicle 100 as traveling on a roadway with surrounding vehicles, which are intended to be construed in a similar manner as vehicle 100 itself. That is, the surrounding vehicles may include any vehicle that may be encountered on a roadway by vehicle 100.

Vehicle 100 also includes various elements. It will be understood that in various embodiments it may not be necessary for vehicle 100 to have all of the elements shown in FIG. 1. Vehicle 100 may have any combination of the various elements shown in FIG. 1. Further, vehicle 100 may have additional elements to those shown in FIG. 1. In some arrangements, vehicle 100 may be implemented without one or more of the elements shown in FIG. 1. While the various elements are shown as being located within vehicle 100 in FIG. 1, it will be understood that one or more of these elements may be located external to vehicle 100. Further, the elements shown may be physically separated by large distances. For example, as discussed, one or more components of the disclosed system may be implemented within a vehicle while further components of the system are implemented within a cloud-computing environment or other system that is remote from vehicle 100.

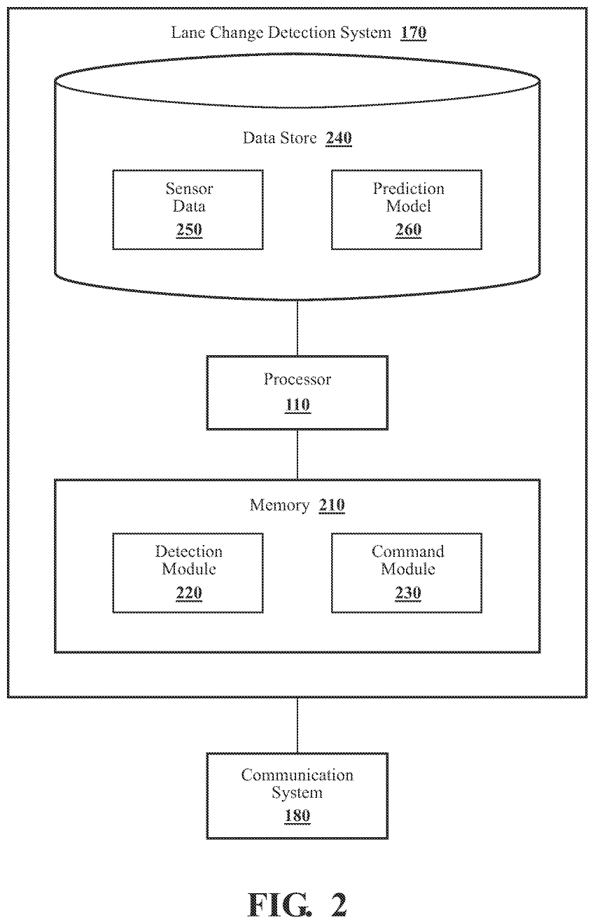

Some of the possible elements of vehicle 100 are shown in FIG. 1 and will be described along with subsequent figures. However, a description of many of the elements in FIG. 1 will be provided after the discussion of FIGS. 2-10 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, vehicle 100 includes a lane change detection system 170 that is implemented to perform methods and other functions as disclosed herein relating to implementing lane change detection strategies. As will be discussed in greater detail subsequently, lane change detection system 170, in various embodiments, is implemented partially within vehicle 100 and as a cloud-based service. For example, in one approach, functionality associated with at least one module of lane change detection system 170 is implemented within vehicle 100 while further functionality is implemented within a cloud-based computing system.

With reference to FIG. 2, one embodiment of lane change detection system 170 of FIG. 1 is further illustrated. Lane change detection system 170 is shown as including processor(s) 110 from vehicle 100 of FIG. 1. Accordingly, processor(s) 110 may be a part of lane change detection system 170, lane change detection system 170 may include a separate processor from processor 110 (s) of vehicle 100, or lane change detection system 170 may access processor 110 (s) through a data bus or another communication path. In one embodiment, lane change detection system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processor(s) 110 cause processor(s) 110 to perform the various functions disclosed herein.

Lane change detection system 170 as illustrated in FIG. 2 is generally an abstracted form of lane change detection system 170 as may be implemented between vehicle 100 and a cloud-computing environment. Accordingly, lane change detection system 170 may be embodied at least in part within a cloud-computing environment to perform the methods described herein.

With reference to FIG. 2, detection module 220 generally includes instructions that function to control processor(s) 110 to receive data inputs from one or more sensors of vehicle 100. The inputs are, in one embodiment, observations of one or more objects in an environment proximate to vehicle 100, other aspects about the surroundings, or both. As provided for herein, detection module 220, in one embodiment, acquires sensor data 250 that includes at least camera images. In further arrangements, detection module 220 acquires sensor data 250 from further sensors such as radar 123, LiDAR 124, and other sensors as may be suitable for identifying vehicles, locations of the vehicles, lane markers, crosswalks, traffic signs, vehicle parking areas, road surface types, curbs, vehicle barriers, and so on. In one embodiment, detection module 220 may also acquire sensor data 250 from one or more sensors that allow for implementing lane change detection strategies.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within vehicle 100. Moreover, detection module 220 may undertake various approaches to fuse data from multiple sensors when providing sensor data 250, from sensor data acquired over a wireless communication link (e.g., v2v) from one or more of the surrounding vehicles, or from a combination thereof. Thus, sensor data 250, in one embodiment, represents a combination of perceptions acquired from multiple sensors.

In addition to locations of surrounding vehicles, sensor data 250 may also include, for example, odometry information, GPS data, or other location data. Moreover, detection module 220, in one embodiment, controls the sensors to acquire sensor data about an area that encompasses 360 degrees about vehicle 100, which may then be stored in sensor data 250. In some embodiments, such area sensor data may be used to provide a comprehensive assessment of the surrounding environment around vehicle 100. Of course, in alternative embodiments, detection module 220 may acquire the sensor data about a forward direction alone when, for example, vehicle 100 is not equipped with further sensors to include additional regions about the vehicle or the additional regions are not scanned due to other reasons (e.g., unnecessary due to known current conditions).

Moreover, in one embodiment, lane change detection system 170 includes a database 240. Database 240 is, in one embodiment, an electronic data structure stored in memory 210 or another data store and that is configured with routines that may be executed by processor(s) 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when separate sensor data 250 was generated, and so on.

Detection module 220, in one embodiment, is further configured to perform additional tasks beyond controlling the respective sensors to acquire and provide sensor data 250. For example, detection module 220 includes instructions that may cause processor(s) 110 to form a probe trace using data from a visual Simultaneous Localization and Mapping (visual SLAM) system stored in sensor data 250. For example, detection module 220 may include in a probe trace, as vehicle 100 moves from one location to another, any information identifying nearby physical objects along the path of travel based on sensor data 250. Such information may be comprised of timestamps, pose/orientation/location of the camera or vehicle, camera images, keypoints, depth measurements, point cloud data (e.g., from LiDAR 124), remote surveillance data (e.g., from a drone, infrastruction devices, satellite), or other data useful for generating maps based on the probe trace. In some embodiments, the probe trace may also contain localization information such as odometry data, GPS data, or other metrics specifying a relative or absolute distance between physical objects along the path of travel based on sensor data 250. In some embodiments, the probe trace may also contain traffic data, such as the number of road users, the types of road users, the average speed of road users, and so on.

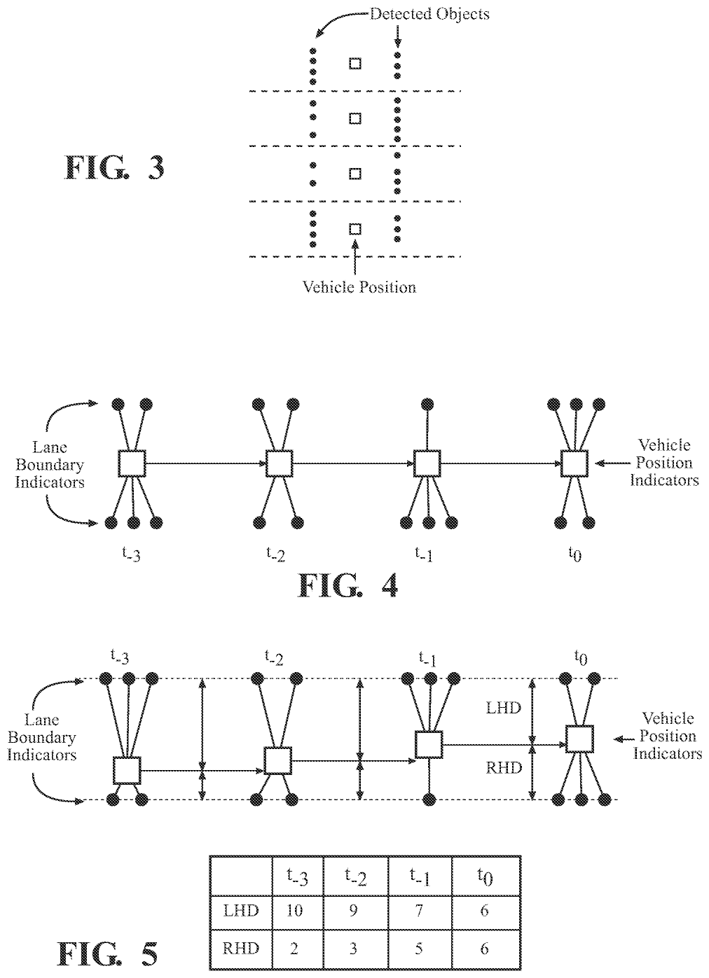

In some embodiments, command module 230 may receive a probe trace (e.g., via sensor data 250) and create a frame graph. For example, as shown in FIG. 3, the probe trace may record the most recent and prior positions of the vehicle (e.g., according to odometry data) and detected objects (e.g., lane markers, curbs) relative to each position.

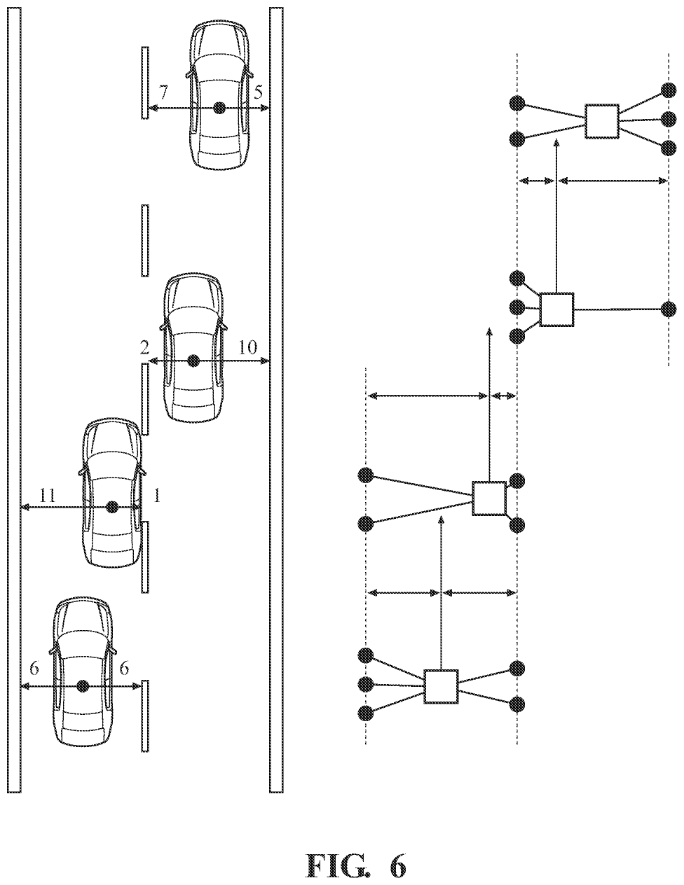

Command module 230 may then process the probe trace data into a frame graph as shown in FIG. 4. For example, the most recent vehicle position data (e.g., representing the center of the vehicle) may be recorded as a first vehicle position indicator. In addition, detected objects indicating the edge of the lane (e.g., lane markers, curbs) associated with the vehicle position indicator may be recorded as lane boundary indicators in a first segment of the frame graph. The first segment at to may then followed by additional segments at t₋₁, . . . , t₋ₙ that were created previously to record prior vehicle position indicators and their associated lane boundary indicators. In some embodiments, command module 230 may omit forming a segment based on an instance of vehicle position data or its associated detected objects, such as where command module 230 determines that the data is invalid. For example, an instance of vehicle position data without any associated detected objects may be skipped over when forming or updating segments in the lane detection frame graph. As another example, associated detected objects relative to the vehicle position data may be rejected where they are outside a specified range from the vehicle position (e.g., greater than a lane width), inconsistent with other associated detected objects (e.g., based on an association heuristic identifying lane markers), and so on. In some embodiments, command module 230 may use a sliding window method in generating the vehicle position indicators or lane boundary indicators.

As additional probe trace data is made available, command module 230 may update the frame graph by moving data backwards in time (e.g., t₀ to t₋₁, t₋₁ to t₋₂) and create a new segment at to. In some embodiments, the lane detection frame graph may have a fixed length of value N, such that any entries after t_{-(N-1)} are deleted from the frame graph. In other embodiments, the lane detection frame graph may have a dynamic length that is adjusted by command module 230. For example, command module 230 may specify a minimum distance (e.g., 100 ft), such that command module 230 only removes a segment from the frame graph when the vehicle position data for that segment is more than 100 ft from the vehicle position data in the first segment. In some embodiments, such a minimum distance may vary based on the speed of vehicle 100.

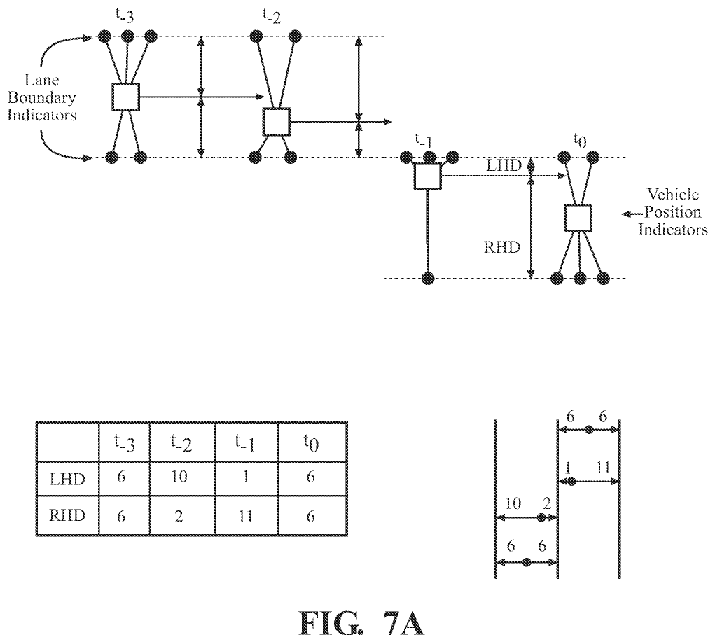

Upon constructing or updating the frame graph, command module 230 may determine with respect to each segment of the frame graph a left-handed distance from the vehicle position indicator within the segment to one or more lane boundary indicators within the segment to the left of the vehicle position indicator. In addition, command module 230 may determine with respect to each segment of the frame graph a right-handed distance from the vehicle position indicator within the segment to one or more lane boundary indicators within the segment to the right of the vehicle position indicator. For example, command module 230 may determine a left-handed distance or right-handed distance based on the mean distance, average distance, maximum distance, minimum distance, or other statistical measures of distance to their respective set of left or right lane boundary indicators. With respect to each segment of the frame graph, a distance to the left and right may then be recorded as shown in FIG. 5. In some embodiments, command module 230 may record the left and right distances for each segment in a table or other data formats.

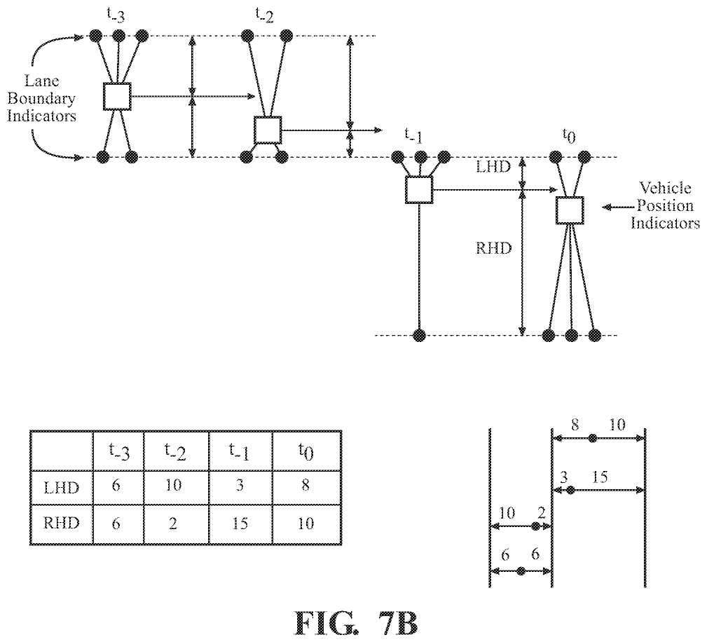

Once left-hand distances and right-hand distances have been computed for each segment, command module 230 may determine if a lane change has occurred. An example of a lane change is shown in FIG. 6, where vehicle 100 makes a lane change to the right. As vehicle 100 progresses from the initial lane to the adjacent lane, the left-handed distances per segment have generally increased over time while the right-handed distances per segment have decreased. This may continue until the center of the vehicle passes over the right lane boundary, at which point the left-handed distances transition to a much lower value, while the right-handed distances transition to a much higher value. Based on such transitions in the values of the left-handed distance, the right-handed distance, or both, command module 230 may determine that a lane change has occurred. For example, command module 230 may detect a transition in the left-handed distance, right-handed distance, or both if they change above a pre-determined threshold (e.g., more than half the lane width) and thus conclude a lane change has occurred.

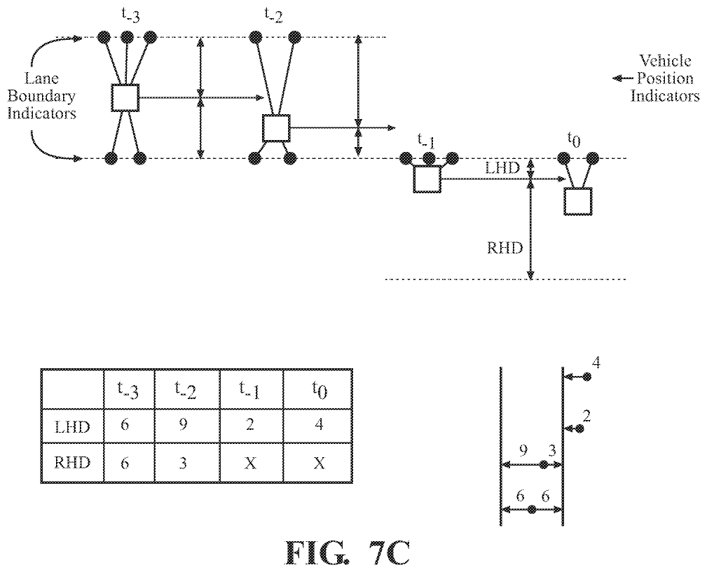

In some embodiments, command module 230 may determine based on a transition in the left-handed distance, right-handed distance, or both, what type of lane change transition has occurred. Several examples of lane change transitions are shown in FIGS. 7A-C. While these examples have generally been described in terms of left-to-right transitions, a similar approach may be used with respect to right-to-left transitions (e.g., with the role of the left-handed distances and right-handed distances inverted).

With respect to FIG. 7A, a transition from one lane to another lane is shown. In this example, a vehicle moves from the center of a 12 ft wide lane to the center of the adjacent 12 ft lane to the right. As shown in FIG. 7A, when the center of the vehicle passed over the lane divider, the right-handed distance transitioned by a value of 9 ft, while the left-handed distance transitioned by a value of −9 ft. In this example, the transition in values of the right-handed distance and the left-handed distance are approximately the same in magnitude. Accordingly, command module 230 may determine that when the right-handed distance and the left-handed distance transition by a similar magnitude, that a standard lane change has occurred (e.g., from a standard 12 ft lane to another 12 ft lane within a roadway). In some embodiments, command module 230 may determine whether the left-handed distance and right-handed distance transition by a similar magnitude based on whether such transitions are within a pre-defined range of each other (e.g., within 2 ft, within 10% of the lane width). In some embodiments, such a pre-defined range may be adjusted based on an estimate of the lane width or other relevant factors. For example, command module 230 may average the sum of the left-handed distances and right-handed distances across one or more segments to form an estimated lane width, then determine a pre-defined range based on function, fraction, or percentage of the estimated lane width (e.g., ¼, 10%).

In some embodiments, command module 230 may also determine the direction of the lane change based on the positive or negative value of transitions in left-handed distances, the right-handed distances, or both. For example, as described in the example above the right-handed distance transitioned by a value of 9 ft, while the left-handed distance also transitioned by a value of −9 ft. In such a situation, command module may determine that a negative transition between left-handed distances, a positive transition between right-distances, or both indicates a right lane change. Similarly, command module may determine that a positive transition between left-handed distances, a negative transition between right-distances, or both indicates a right lane change.

With respect to FIG. 7B, a transition from one lane to a split/merge lane (e.g., a wider lane that is either going to split or is imposing a merger) is shown. In this example, a vehicle moves from the center of a 12 ft wide lane into an adjacent 18 ft wide split/merge lane on the right. As shown in FIG. 7B, when the center of the vehicle passed over the lane divider, the right-handed distance transitioned by a value of 13 ft, while the left-handed distance transitioned by a value of −7 ft. In this example, the transition in values of the right-handed distance and the left-handed distance are dissimilar in magnitude. Accordingly, command module 230 may determine that when the right-handed distance and the left-handed distance transitions are dissimilar, such that right-handed distance has transitioned more in magnitude than the left-handed distance has transitioned or vice versa, that a split/merge lane change has occurred (e.g., from a standard 12 ft lane to a larger lane for merging or splitting off from the roadway). In some embodiments, command module 230 may determine that the transitions are dissimilar based on whether such values are outside of a pre-defined range of each other (e.g., outside of 2 ft, further than 10% of the lane width). In some embodiments, the pre-defined range may be adjusted based on an estimate of the lane width as previously described herein.

In some embodiments, command module 230 may further determine whether a split/merge lane change is a merge lane or a split lane based on whether the sum of the left-handed distance and the right-handed distance per segment are increasing (split) or decreasing (merger) as vehicle 100 moves forward. In some embodiments, if the sum of the left-handed distance and the right-handed distance per segment increases above a pre-defined value (e.g., 20 ft), command module 230 may generate a road split warning to indicate that a road split may be about to occur. In some embodiments, if the sum of the left-handed distance and the right-handed distance per segment decreases below a pre-defined value (e.g., 14 ft), command module 230 may generate a road merge warning to indicate that a merge lane is about to end.

In some embodiments, command module 230 may further determine whether a split/merge lane change is a merge lane or a split lane based on the positive or negative value of transitions in left-handed distances, the right-handed distances, or both as vehicle 100 moves forward. For example, if transitions of the left-handed distances, the right-handed distance, or both show a positive trend over time, command module 230 may generate a road split warning to indicate that a road split may be about to occur. As another example, if transitions of the left-handed distances, the right-handed distance, or both show a negative trend over time, command module 230 may generate a road merge warning to indicate that a merge lane is about to end.

In some embodiments, if the sum of the left-handed distance and the right-handed distance per segment decreases below a pre-defined value (e.g., 8 ft), command module 230 may generate a lane end warning to indicate that a lane may be ceasing to exist ahead. In some embodiments, if the sum of the left-handed distance and the right-handed distance continue to decrease after the lane end warning and no corrective action is taken (e.g., within a pre-determined time) or a minimum required lane width condition is violated, command module 230 may implement a safety response such as slowing down or stopping the vehicle, executing a lane change, or increasing the intensity of notifications.

In some embodiments, if the sum of the left-handed distance and the right-handed distance per segment continue to increase after a road split warning, command module 230 may determine if the vehicle is properly positioned for a lane split. For example, command module 230 may determine based on whether the left-handed distance(s) or right-handed distance(s) of the most recent segment(s) are below a pre-determined distance (e.g., 4 ft) whether the vehicle is prepared to split to the left or to the right should a lane split occur. For example, if the left-handed distance of the most recent segment is under 4 ft, then command module 230 may determine that vehicle 100 is properly prepared to go the left after a potential road split. Alternatively, if the right-handed distance of the most recent segment is under 4 ft, then command module 230 may determine that vehicle 100 is properly prepared to go the right after a potential road split. If though the left-handed distance(s) or right-handed distances(s) do not satisfy either condition, command module 230 may implement a safety response such as slowing down or stopping the vehicle, moving the vehicle sufficiently to the right or left to satisfy such a condition (e.g., based on whichever distance is smaller in magnitude), or increasing the intensity of notifications.

With respect to FIG. 7C, a transition from a lane to off-road is shown. In this example, a vehicle moves from the center of a 12 ft wide lane to a shoulder on the right. As shown in FIG. 7C, when the center of the vehicle passed over the lane divider, the right-handed distance became indefinite, while the left-handed distance transitions by a value of −9 ft. In this context, the transition in magnitude of the left-handed distance is similar to examples described above, but no comparison can be made with the right-handed distance due to its indefiniteness. Accordingly, command module 230 may determine that when left-handed distance transitions within an acceptable range, but the right-handed distance has become indefinite that a shoulder/off-range lane change has occurred. A left-handed distance or right-handed distance may be considered indefinite if it is not included in a segment, if command module 230 determines that there is too much variation in the left-handed distance or right-handed distance across segments (e.g., transitions in the left-handed distance or right-handed distance across segments is greater than 10% of the lane width, transitions of a left-handed distance across segments are higher (e.g., greater than 20%) than the right-handed distance or vice versa).

With respect to FIG. 7D, a series of back-and forth transitions from one lane to another lane is shown. In this example, a vehicle such as a motorcycle may be engaged in lane splitting, such that it is passing back and forth over a lane boundary. As shown in FIG. 7D, with each pass of the vehicle back and forth across the lane divider, the left-handed distance and right-handed distance transition back and forth in values. Accordingly, command module 230 may determine that when the right-handed distance and the left-handed distance are transitioning back and forth for more than a pre-determined number of transitions within a pre-defined period of time (e.g., more than 2 transitions within 10 seconds), that a lane change into a lane splitting condition has occurred. In some embodiments, command module 230 may determine that the lane splitting condition continues until the left-handed distance or right-handed distance is above or below one or more thresholds (e.g., the magnitude of the left-handed distance or right-handed distance must be above 2 ft) or a transition does not occur within a pre-defined period of time (e.g., more than 20 seconds). Upon detecting a lane splitting condition, command module 230 may instruct vehicle 100 to notify the driver that a lane splitting condition exists; reduce or restrict the speed of vehicle 100; execute a maneuver so as to leave the lane splitting condition, or a combination thereof.

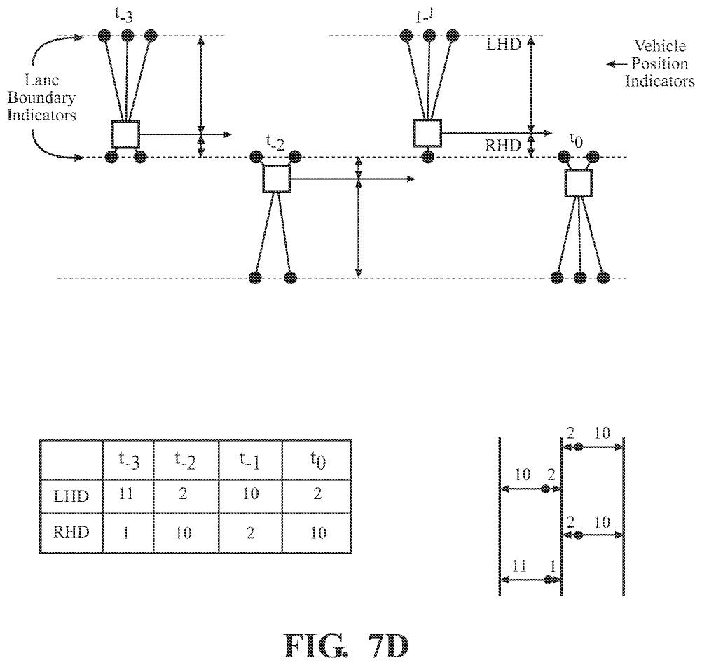

In some embodiments, command module 230 may evaluate lane change events with respect to groupings of two or more vehicles. For example, as shown in FIG. 8A, a truck and a trailer may be represented by a first and second vehicle position indicators. In some embodiments, command module 230 may construct a grouping of vehicles, such as by receiving information that an articulated trailer is connected to a vehicle or that a hitchless towing configuration applies between two or more vehicles. When command module 230 receives indication of a vehicle grouping, it may perform lane change determinations for both vehicles as described herein. In some embodiments, a frame graph for a following vehicle may be supplemented with information available in the frame graph for a lead vehicle. For example, as a following vehicle may be trailing a lead vehicle at a known distance, lane boundary indicators based on the prior vehicle positions of the lead vehicle may be used to provide lane boundary indicators for the following vehicle. As shown in FIG. 8B, one such approach is to copy the lane boundary indicators in a segment of the lead vehicle frame graph to a segment of the following vehicle frame graph based on which prior lead vehicle position indicator is closest to the following vehicle position indicator. In some embodiments, an interpolation between the lane boundary indicators of the two lead vehicle segments closest to a following vehicle position indicator may copied into the appropriate segment of the following vehicle's frame graph.

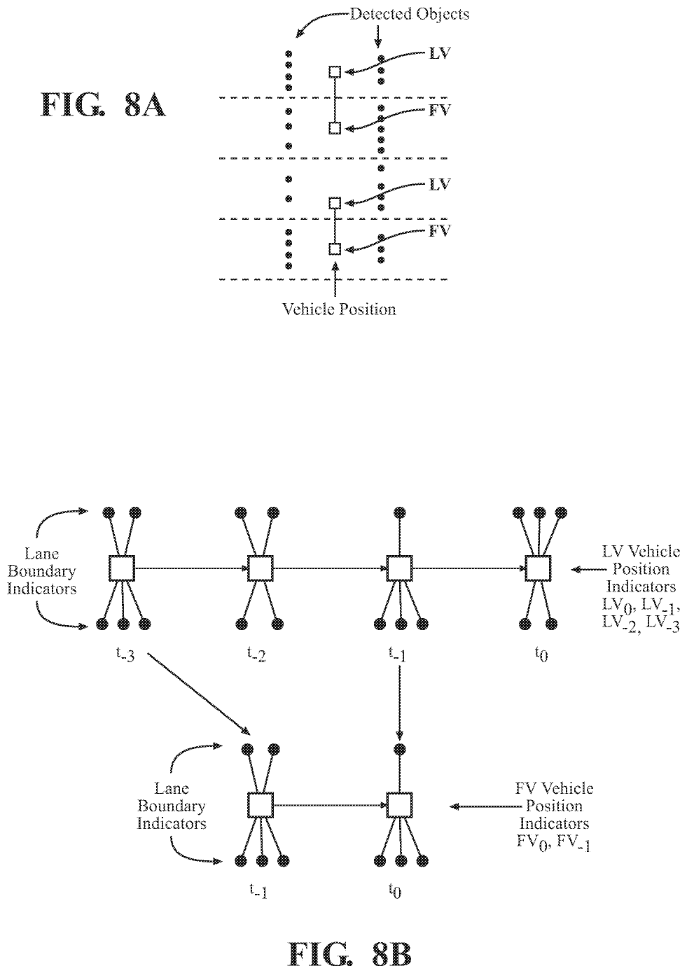

In some embodiments, command module 230 may perform lane change analysis described herein with respect to a vehicle contour associated with a vehicle (e.g., vehicle 100) as shown in FIG. 9. In such an embodiment, the initial right-handed distances and left-handed distances may correspond, respectively, to the distances from the right lateral vehicle contour boundary or left lateral vehicle contour boundary of the vehicle contour to the right or left lane boundary indicators. If command module 230 receives the right-handed and left-handed distances in such a vehicle contour defined format, it may adjust the right-handed and left-handed distances based on the lateral distances of the contour boundaries from the center of the vehicle such that the right-handed and left-handed distances are measured from the center of the vehicle. For example, such a process may be beneficial where the lane boundaries for a vehicle (e.g., a trailer) and left-hand/right-hand distances are obtained using only information from cameras mounted on the sides of a vehicle.

In some embodiments, when vehicle contours are defined for a vehicle, command module 230 may use the vehicle contours to determine if the vehicle associated with the vehicle contour is sufficiently within a lane (e.g., before or after a lane change). For example, command module 230 may only designate that a lane change is complete when the left-handed or right-handed distances satisfy one or more criteria associated with the vehicle position indicator, the lane width, and the vehicle contour width. Examples of the one or more criteria may be: that the vehicle position indicator is within a pre-determine range of the lane, where such range may be adjusted based on the vehicle contour width and a safety margin factor (e.g., the range is equal to or less than ((lane width)−(vehicle contour width)−(safety margin factor))/2); that the left-handed distance, the right-handed distance, or both are in excess of half the vehicle contour width plus an safety margin factor; the left-handed frame-edge distance, the right-handed frame-edge distance, or both are above a pre-determined distance (e.g., 1 ft); and so on. In a situation where such one or more criteria are not met, command module 230 may determine that the vehicle is in a lane splitting condition.

In some embodiments, command module 230 may estimate a left-handed distance or right-handed distance for a segment in a frame graph where lane boundary indicators are not available. For example, if a vehicle can only observe a road using side-view cameras then lane markers may not be detected if the vehicle is driving over them. In such a situation where command module 230 determines that the line divider has passed under the vehicle, command module 230 may estimate a left-handed distance or right-handed distance by subtracting the nearest available left-handed distance or right-handed distance from an estimated lane width. For example, if a vehicle makes a standard lane change to right, then once the lane marker goes under the vehicle the right-handed distance may be calculated based on the estimated lane width minus the left-handed distance. After the center of the vehicle is estimated to have passed over the line divider (e.g., because the estimated lane width minus the left-handed distance is negative), the left-handed distance may be estimated based on the estimated lane width minus the left-handed distance. While the preceding example assumes the estimated lane width is the same for both lanes, command module 230 may use an initial lane or final lane estimated lane width depending on which side of the lane divider the center of the vehicle is estimated to be on.

In some embodiments, command module 230 may incorporate lane boundary type information from sensor data 250 into a lane change determination. For example, sensor data 250 may indicate that the lane boundary indicators have a lane boundary type associated with a high-occupancy vehicle (HOV) lane; an oncoming traffic lane (e.g., double yellow, dashed yellow); a shoulder (e.g., white lane), etc. Accordingly, command module 230 may use lane boundary type data or other information in sensor data 250 to determine a lane type (e.g., HOV, oncoming traffic lane, shoulder) for vehicle 100's current lane or an adjacent lane. For example, if the lane boundary indicators to the right of vehicle 100 are associated with a shoulder, command module 230 may determine that the vehicle is travelling in a standard lane next to a road shoulder on the right.

In some embodiments, if vehicle 100 seeks to execute or completes a lane change, command module 230 may evaluate whether vehicle 100 has satisfied one or more lane conditions associated with the lane type determination for that lane. For example, command module 230 may evaluate whether vehicle 100 has a sufficient number of occupants to operate in an HOV lane; whether vehicle 100 has crossed over parallel lines into an oncoming traffic lane; whether vehicle 100 is travelling too fast for a restricted-speed lane; and so on. If command module 230 determines that vehicle 100 does not satisfy one or more lane conditions associated with the lane type, it may issue a warning (e.g., describing the condition(s) violated); a corrective action to the driver or vehicle 100 (e.g., make a lane change back out of the oncoming traffic lane); and so on.

In some embodiments, command module 230 may determine the amount of time that was taken to complete a lane change. For example, command module 230 may detect the beginning of a lane change when a left-handed distance or right-handed distance is below a pre-determined threshold (e.g., under 1 ft). Next, as described herein, command module 230 may detect the end of a lane change (e.g., after a transition occurs in the left-handed or right-handed distance, when the vehicle position indicator is within a pre-determined range of the center of the lane). Based on the time when the lane change was determined to begin and the time when the lane change was determined to end, command module 230 may estimate a lane change time. In some embodiments, command module 230 may undertake a response action if the lane change time does not satisfy one or more criteria, which may be adjusted based on the speed of vehicle 100 or other factors. For example, if the lane change time is very short and fails a minimum lane change time condition (e.g., less than 2 s), command module 230 may send instructions to vehicle 100 to initiate pre-crash measures (e.g., activating advanced driver assistance, triggering seat belt pretensioners). As another example, if the lane change time is excessive and fails a maximum lane change time condition (e.g., more than 15 s), command module 230 may determine that a driver may be incapacitated and generate alerts (e.g., haptic feedback, audio alerts, text messages) to stimulate the driver. In some embodiments, if the trajectory of the vehicle does not change after an incapacitation alert (e.g., the rate of change in a right-handed distance or left-handed distance remains the same), command module 230 may instruct vehicle 100 to slow down, stop, execute a lane change, or undertake other safety responses.

In some embodiments, when command module 230 determines that a lane change has completed it may instruct vehicle 100 to provide haptic feedback (e.g., vibrate steering wheel), audio or visual alerts, or other notifications to indicate that the vehicle has completed the lane change. Such an approach may be used, for instance, where vehicle 100 belongs to a grouping of vehicles and command module 230 determines that the grouping of vehicles as a whole has completed the lane change.

It should be appreciated that command module 230 in combination with a prediction model 260 may form a computational model such as a machine learning logic, deep learning logic, a neural network model, or another similar approach. In one embodiment, prediction model 260 is a statistical model such as a regression model that may provide lane boundary markers and vehicle position indicators described herein based on sensor data 250 or other sources of information as described herein. Accordingly, predictive model 260 may be a polynomial regression, least squares or another suitable approach.

Moreover, in alternative arrangements, prediction model 260 is a probabilistic approach such as a hidden Markov model. In either case, command module 230, when implemented as a neural network model or another model, in one embodiment, electronically accepts sensor data 250 as an input, which may also include probe trace data. Accordingly, command module 230 in concert with prediction model 260 may produce various determinations/assessments as an electronic output that characterizes the noted aspect as, for example, a single electronic value. Moreover, in further aspects, lane change detection system 170 may collect the noted data, log responses, and use the data and responses to subsequently further train predictive model 260.

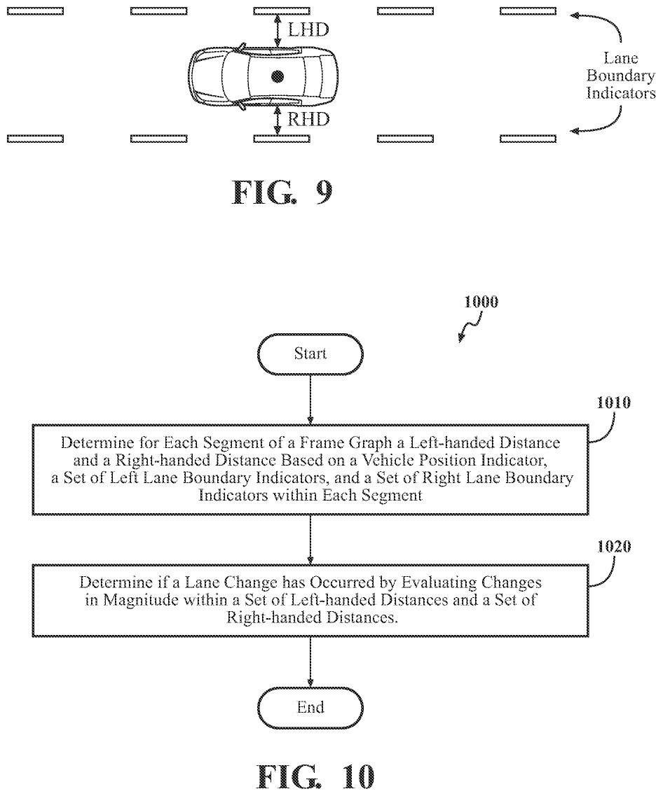

FIG. 10 illustrates a flowchart of a method 1000 that is associated with implementing lane change detection strategies. Method 1000 will be discussed from the perspective of the lane change detection system 170 of FIGS. 1 and 2. While method 1000 is discussed in combination with the lane change detection system 170, it should be appreciated that the method 1000 is not limited to being implemented within lane change detection system 170 but is instead one example of a system that may implement method 1000.

At 1010, command module 230 may determine for each segment of a frame graph a left-handed distance and a right-handed distance based on a vehicle position indicator, a set of left lane boundary indicators, and a set of right lane boundary indicators within each segment. For example, command module 230 may determine with respect to each segment of the frame graph a left-handed distance from the vehicle position indicator within the segment to one or more lane boundary indicators within the segment to the left of the vehicle position indicator. In addition, command module 230 may determine with respect to each segment of the frame graph a right-handed distance from the vehicle position indicator within the segment to one or more lane boundary indicators within the segment to the right of the vehicle position indicator. For example, command module 230 may determine a left-handed distance or right-handed distance based on the mean distance, average distance, maximum distance, minimum distance, or other statistical measures of distance to their respective set of left or right lane boundary indicators.

At 1020, command module 230 may determine if a lane change has occurred by evaluating changes in magnitude within a set of left-handed distances and a set of right-handed distances. For example, based on such transitions between segments in the values of the left-handed distance, the right-handed distance, or both, command module 230 may determine that a lane change has occurred. Command module 230 may detect a transition in the left-handed distance, right-handed distance, or both if they change above a pre-determined threshold (e.g., more than half the lane width) and thus conclude a lane change has occurred.

In some embodiments, command module 230 may determine based on a transition in the left-handed distance, right-handed distance, or both, what type of lane change transition has occurred. In some embodiments, command module 230 may determine that when the right-handed distance and the left-handed distance transition by a similar magnitude, that a standard lane change has occurred (e.g., from a standard 12 ft lane to another 12 ft lane within a roadway). In some embodiments, command module 230 may determine whether the left-handed distance and right-handed distance transition by a similar magnitude based on a similarity criterion, such as for example whether such changes in magnitude are within a pre-defined range of each other (e.g., within 2 ft, within 10% of the lane width). In some embodiments, such a pre-defined range may be adjusted based on an estimate of the lane width or other relevant factors. For example, command module 230 may average the sum of the left-handed distances and right-handed distances across one or more segments to form an estimated lane width, then determine a pre-defined range based on function, fraction, or percentage of the estimated lane width (e.g., ¼, 10%).

In some embodiments, command module 230 may determine that when the right-handed distance and the left-handed distance transitions are dissimilar, such as when between segments the right-handed distance has transitioned more in magnitude than the left-handed distance has transitioned or vice versa, that a split/merger lane change has occurred (e.g., from a standard 12 ft lane to a larger lane for merging or splitting off from the roadway). In some embodiments, command module 230 may determine that the transitions in values are dissimilar based on a dissimilarity criterion, such as for example whether such changes in magnitude are outside of a pre-defined range of each other (e.g., outside of 2 ft, further than 10% of the lane width). In some embodiments, the pre-defined range for a dissimilarity criterion may be adjusted based on an estimate of the lane width as previously described herein.

In some embodiments, command module 230 may also further determine the direction of a lane change based on the increase or decrease in a left-handed distance, right-handed distance, or both when a transition demonstrating a lane change occurs. For example, if during a lane change the left-handed distance decreases in magnitude, the right-handed distance increases in magnitude, or both, then command module 230 may determine that a lane change to the right has occurred. Similarly, if during a lane change the left-handed distance increases in magnitude, the right-handed distance decreases in magnitude, or both, then command module 230 may determine that a lane change to the left has occurred.

FIG. 1 will now be discussed in full detail as an example environment within which the system and methods disclosed herein may operate. In some instances, vehicle 100 is configured to switch selectively between various modes, such as an autonomous mode, one or more semi-autonomous operational modes, a manual mode, etc. Such switching may be implemented in a suitable manner, now known, or later developed. “Manual mode” means that all of or a majority of the navigation/maneuvering of the vehicle is performed according to inputs received from a user (e.g., human driver). In one or more arrangements, vehicle 100 may be a conventional vehicle that is configured to operate in only a manual mode.

In one or more embodiments, vehicle 100 is an autonomous vehicle. As used herein, “autonomous vehicle” refers to a vehicle that operates in an autonomous mode. “Autonomous mode” refers to using one or more computing systems to control vehicle 100, such as providing navigation/maneuvering of vehicle 100 along a travel route, with minimal or no input from a human driver. In one or more embodiments, vehicle 100 is either highly automated or completely automated. In one embodiment, vehicle 100 is configured with one or more semi-autonomous operational modes in which one or more computing systems perform a portion of the navigation/maneuvering of the vehicle along a travel route, and a vehicle operator (i.e., driver) provides inputs to the vehicle to perform a portion of the navigation/maneuvering of vehicle 100 along a travel route.

Vehicle 100 may include one or more processors 110. In one or more arrangements, processor(s) 110 may be a main processor of vehicle 100. For instance, processor(s) 110 may be an electronic control unit (ECU). Vehicle 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

In one or more arrangements, data store(s) 115 may include map data 116. Map data 116 may include maps of one or more geographic areas. In some instances, map data 116 may include information or data on roads, traffic control devices, road markings, structures, features, landmarks, or any combination thereof in the one or more geographic areas. Map data 116 may be in any suitable form. In some instances, map data 116 may include aerial views of an area. In some instances, map data 116 may include ground views of an area, including 360-degree ground views. Map data 116 may include measurements, dimensions, distances, information, or any combination thereof for one or more items included in map data 116. Map data 116 may also include measurements, dimensions, distances, information, or any combination thereof relative to other items included in map data 116. Map data 116 may include a digital map with information about road geometry. Map data 116 may be high quality, highly detailed, or both.

In one or more arrangements, map data 116 may include one or more terrain maps 117. Terrain map(s) 117 may include information about the ground, terrain, roads, surfaces, other features, or any combination thereof of one or more geographic areas. Terrain map(s) 117 may include elevation data in the one or more geographic areas. Terrain map(s) 117 may be high quality, highly detailed, or both. Terrain map(s) 117 may define one or more ground surfaces, which may include paved roads, unpaved roads, land, and other things that define a ground surface.

In one or more arrangements, map data 116 may include one or more static obstacle maps 118. Static obstacle map(s) 118 may include information about one or more static obstacles located within one or more geographic areas. A “static obstacle” is a physical object whose position does not change or substantially change over a period of time and whose size does not change or substantially change over a period of time. Examples of static obstacles include trees, buildings, curbs, fences, railings, medians, utility poles, statues, monuments, signs, benches, furniture, mailboxes, large rocks, hills. The static obstacles may be objects that extend above ground level. The one or more static obstacles included in static obstacle map(s) 118 may have location data, size data, dimension data, material data, other data, or any combination thereof, associated with it. Static obstacle map(s) 118 may include measurements, dimensions, distances, information, or any combination thereof for one or more static obstacles. Static obstacle map(s) 118 may be high quality, highly detailed, or both. Static obstacle map(s) 118 may be updated to reflect changes within a mapped area.

Data store(s) 115 may include sensor data 119. In this context, “sensor data” means any information about the sensors that vehicle 100 is equipped with, including the capabilities and other information about such sensors. As will be explained below, vehicle 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of map data 116 or sensor data 119 may be located in data stores(s) 115 located onboard vehicle 100. Alternatively, or in addition, at least a portion of map data 116 or sensor data 119 may be located in data stores(s) 115 that are located remotely from vehicle 100.

As noted above, vehicle 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of vehicle 100 (including any of the elements shown in FIG. 1), or any combination thereof. Sensor system 120 may acquire data of at least a portion of the external environment of vehicle 100 (e.g., nearby vehicles).

Sensor system 120 may include any suitable type of sensor. Various examples of different types of sensors will be described herein. However, it will be understood that the embodiments are not limited to the particular sensors described. Sensor system 120 may include one or more vehicle sensors 121. Vehicle sensor(s) 121 may detect, determine, sense, or acquire in a combination thereof information about vehicle 100 itself. In one or more arrangements, vehicle sensor(s) 121 may be configured to detect, sense, or acquire in a combination thereof position and orientation changes of vehicle 100, such as, for example, based on inertial acceleration. In one or more arrangements, vehicle sensor(s) 121 may include one or more accelerometers, one or more gyroscopes, an inertial measurement unit (IMU), a dead-reckoning system, a global navigation satellite system (GNSS), a global positioning system (GPS), a navigation system 147, other suitable sensors, or any combination thereof. Vehicle sensor(s) 121 may be configured to detect, sense, or acquire in a combination thereof one or more characteristics of vehicle 100. In one or more arrangements, vehicle sensor(s) 121 may include a speedometer to determine a current speed of vehicle 100.

Alternatively, or in addition, sensor system 120 may include one or more environment sensors 122 configured to acquire, sense, or acquire in a combination thereof driving environment data. “Driving environment data” includes data or information about the external environment in which an autonomous vehicle is located or one or more portions thereof. For example, environment sensor(s) 122 may be configured to detect, quantify, sense, or acquire in any combination thereof obstacles in at least a portion of the external environment of vehicle 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of vehicle 100, such as, for example, lane markers, signs, traffic lights, traffic signs, lane lines, crosswalks, curbs proximate to vehicle 100, off-road objects, etc.

Various examples of sensors of sensor system 120 will be described herein. The example sensors may be part of the one or more environment sensor(s) 122, the one or more vehicle sensors 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more cameras 126, or any combination thereof. In one or more arrangements, camera(s) 126 may be high dynamic range (HDR) cameras or infrared (IR) cameras.

Vehicle 100 may include an input system 130. An “input system” includes any device, component, system, element or arrangement or groups thereof that enable information/data to be entered into a machine. Input system 130 may receive an input from a vehicle passenger (e.g., a driver or a passenger). Vehicle 100 may include an output system 135. An “output system” includes any device, component, or arrangement or groups thereof that enable information/data to be presented to a vehicle passenger (e.g., a person, a vehicle passenger, etc.).

Vehicle 100 may include one or more vehicle systems 140. Various examples of vehicle system(s) 140 are shown in FIG. 1. However, vehicle 100 may include more, fewer, or different vehicle systems. It should be appreciated that although particular vehicle systems are separately defined, each or any of the systems or portions thereof may be otherwise combined or segregated via hardware, software, or a combination thereof within vehicle 100. Vehicle 100 may include a propulsion system 141, a braking system 142, a steering system 143, throttle system 144, a transmission system 145, a signaling system 146, a navigation system 147, other systems, or any combination thereof. Each of these systems may include one or more devices, components, or combinations thereof, now known or later developed.

Navigation system 147 may include one or more devices, applications, or combinations thereof, now known or later developed, configured to determine the geographic location of the vehicle 100, to determine a travel route for vehicle 100, or to determine both. Navigation system 147 may include one or more mapping applications to determine a travel route for vehicle 100. Navigation system 147 may include a global positioning system, a local positioning system, a geolocation system, or any combination thereof.

Processor(s) 110, lane change detection system 170, automated driving module(s) 160, or any combination thereof may be operatively connected to communicate with various aspects of vehicle system(s) 140 or individual components thereof. For example, returning to FIG. 1, processor(s) 110, automated driving module(s) 160, or a combination thereof may be in communication to send or receive information from various aspects of vehicle system(s) 140 to control the movement, speed, maneuvering, heading, direction, etc. of vehicle 100. Processor(s) 110, lane change detection system 170, automated driving module(s) 160, or any combination thereof may control some or all of these vehicle system(s) 140 and, thus, may be partially or fully autonomous.

Processor(s) 110, lane change detection system 170, automated driving module(s) 160, or any combination thereof may be operable to control at least one of the navigation or maneuvering of vehicle 100 by controlling one or more of vehicle systems 140 or components thereof. For instance, when operating in an autonomous mode, processor(s) 110, lane change detection system 170, automated driving module(s) 160, or any combination thereof may control the direction, speed, or both of vehicle 100. Processor(s) 110, lane change detection system 170, automated driving module(s) 160, or any combination thereof may cause vehicle 100 to accelerate (e.g., by increasing the supply of fuel provided to the engine), decelerate (e.g., by decreasing the supply of fuel to the engine, by applying brakes), change direction (e.g., by turning the front two wheels), or perform any combination thereof. As used herein, “cause” or “causing” means to make, force, compel, direct, command, instruct, enable, or in any combination thereof an event or action to occur or at least be in a state where such event or action may occur, either in a direct or indirect manner.

Vehicle 100 may include one or more actuators 150. Actuator(s) 150 may be any element or combination of elements operable to modify, adjust, alter, or in any combination thereof one or more of vehicle systems 140 or components thereof to responsive to receiving signals or other inputs from processor(s) 110, automated driving module(s) 160, or a combination thereof. Any suitable actuator may be used. For instance, actuator(s) 150 may include motors, pneumatic actuators, hydraulic pistons, relays, solenoids, and piezoelectric actuators, just to name a few possibilities.

Vehicle 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Vehicle 100 may include one or more autonomous driving modules 160. Automated driving module(s) 160 may be configured to receive data from sensor system 120 or any other type of system capable of capturing information relating to vehicle 100, the external environment of the vehicle 100, or a combination thereof. In one or more arrangements, automated driving module(s) 160 may use such data to generate one or more driving scene models. Automated driving module(s) 160 may determine position and velocity of vehicle 100. Automated driving module(s) 160 may determine the location of obstacles, obstacles, or other environmental features including traffic signs, trees, shrubs, neighboring vehicles, pedestrians, etc.

Automated driving module(s) 160 may be configured to receive, determine, or in a combination thereof location information for obstacles within the external environment of vehicle 100, which may be used by processor(s) 110, one or more of the modules described herein, or any combination thereof to estimate: a position or orientation of vehicle 100; a vehicle position or orientation in global coordinates based on signals from a plurality of satellites or other geolocation systems; or any other data/signals that could be used to determine a position or orientation of vehicle 100 with respect to its environment for use in either creating a map or determining the position of vehicle 100 in respect to map data.

Automated driving module(s) 160 either independently or in combination with lane change detection system 170 may be configured to determine travel path(s), current autonomous driving maneuvers for vehicle 100, future autonomous driving maneuvers, modifications to current autonomous driving maneuvers, etc. Such determinations by automated driving module(s) 160 may be based on data acquired by sensor system 120, driving scene models, data from any other suitable source such as determinations from sensor data 250, or any combination thereof. In general, automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include accelerating, decelerating, braking, turning, moving in a lateral direction of vehicle 100, changing travel lanes, merging into a travel lane, and reversing, just to name a few possibilities. Automated driving module(s) 160 may be configured to implement driving maneuvers. Automated driving module(s) 160 may cause, directly or indirectly, such autonomous driving maneuvers to be implemented. As used herein, “cause” or “causing” means to make, command, instruct, enable, or in any combination thereof an event or action to occur or at least be in a state where such event or action may occur, either in a direct or indirect manner. Automated driving module(s) 160 may be configured to execute various vehicle functions, whether individually or in combination, to transmit data to, receive data from, interact with, or to control vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-10, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory communicably coupled to the processor and storing machine-readable instructions that, when executed by the processor, cause the processor to:
determine for each segment of a frame graph a left-handed distance and a right-handed distance based on a vehicle position indicator, a set of left lane boundary indicators, and a set of right lane boundary indicators within each segment; and
determine if a lane change has occurred by evaluating changes in magnitude within a set of left-handed distances and a set of right-handed distances.

2. The system of claim 1, wherein a lane change is determined to have occurred if a first difference in magnitude between two left-handed distances within the set of left-handed distances and a second difference in magnitude between two right-handed distances within the set of right-handed distances satisfy a similarity criterion.

3. The system of claim 1, wherein a split/merge lane change is determined to have occurred if a first difference in magnitude between two left-handed distances within the set of left-handed distances and a second difference in magnitude between two right-handed distances within the set of right-handed distances satisfy a dissimilarity criterion.

4. The system of claim 3, wherein the machine-readable instructions further includes an instruction to:
determine if a potential lane split/merge exists based on whether a sum of the first difference and the second difference satisfies a lane split/merge criteria.

5. The system of claim 1, wherein the machine-readable instructions further includes an instruction to:
determine for each segment of a following vehicle frame graph a secondary left-handed distance and a secondary right-handed distance based on a following vehicle position indicator, a set of secondary left lane boundary indicators, and a set of secondary right lane boundary indicators within each segment; and
determine if a secondary lane change has occurred by evaluating changes in magnitude within a set of secondary left-handed distances and a set of secondary right-handed distances.

6. The system of claim 5, wherein the machine-readable instructions further includes instructions to:
generate one or more secondary left lane boundary indicators or right lane boundary indicators based on the frame graph.

7. The system of claim 1, wherein the machine-readable instructions further includes instructions to:
determine a lane type based on lane boundary type; and
determine if a lane condition has been satisfied based on the lane type if the lane change has occurred.

8. A non-transitory computer-readable medium including instructions that when executed by one or more processors cause the one or more processors to:
determine for each segment of a frame graph a left-handed distance and a right-handed distance based on a vehicle position indicator, a set of left lane boundary indicators, and a set of right lane boundary indicators within each segment; and
determine if a lane change has occurred by evaluating changes in magnitude within a set of left-handed distances and a set of right-handed distances.

9. The non-transitory computer-readable medium of claim 8, wherein a lane change is determined to have occurred if a first difference in magnitude between two left-handed distances within the set of left-handed distances and a second difference in magnitude between two right-handed distances within the set of right-handed distances satisfy a similarity criterion.

10. The non-transitory computer-readable medium of claim 8, wherein a split/merge lane change is determined to have occurred if a first difference in magnitude between two left-handed distances within the set of left-handed distances and a second difference in magnitude between two right-handed distances within the set of right-handed distances satisfy a dissimilarity criterion.

11. The non-transitory computer-readable medium of claim 10, wherein the instructions further includes an instruction to:
determine if a potential lane split/merge exists based on whether a sum of the first difference and the second difference satisfies a lane split/merge criteria.

12. The non-transitory computer-readable medium of claim 8, wherein the instructions further includes an instruction to:
determine for each segment of a following vehicle frame graph a secondary left-handed distance and a secondary right-handed distance based on a following vehicle position indicator, a set of secondary left lane boundary indicators, and a set of secondary right lane boundary indicators within each segment; and
determine if a secondary lane change has occurred by evaluating changes in magnitude within a set of secondary left-handed distances and a set of secondary right-handed distances.

13. The non-transitory computer-readable medium of claim 12, wherein the instructions further includes instructions to:
generate one or more secondary left lane boundary indicators or right lane boundary indicators based on the frame graph.

14. A method, comprising:
determining for each segment of a frame graph a left-handed distance and a right-handed distance based on a vehicle position indicator, a set of left lane boundary indicators, and a set of right lane boundary indicators within each segment; and
determining if a lane change has occurred by evaluating changes in magnitude within a set of left-handed distances and a set of right-handed distances.

15. The method of claim 14, wherein a lane change is determined to have occurred if a first difference in magnitude between two left-handed distances within the set of left-handed distances and a second difference in magnitude between two right-handed distances within the set of right-handed distances satisfy a similarity criterion.

16. The method of claim 14, wherein a split/merge lane change is determined to have occurred if a first difference in magnitude between two left-handed distances within the set of left-handed distances and a second difference in magnitude between two right-handed distances within the set of right-handed distances satisfy a dissimilarity criterion.

17. The method of claim 16, further comprising:
determining if a potential lane split/merge exists based on whether a sum of the first difference and the second difference satisfies a lane split/merge criteria.

18. The method of claim 14, further comprising:
determining for each segment of a following vehicle frame graph a secondary left-handed distance and a secondary right-handed distance based on a following vehicle position indicator, a set of secondary left lane boundary indicators, and a set of secondary right lane boundary indicators within each segment; and
determining if a secondary lane change has occurred by evaluating changes in magnitude within a set of secondary left-handed distances and a set of secondary right-handed distances.

19. The method of claim 18, further comprising:
generating one or more secondary left lane boundary indicators or right lane boundary indicators based on the frame graph.

20. The method of claim 14, further comprising:
determining a lane type based on lane boundary type; and
determining if a lane condition has been satisfied based on the lane type if the lane change has occurred.
